(19) United States
(12) Patent Application Publication
(10) Pub. No.: US 2025/0334991 A1
(43) Pub. Date: Oct. 30, 2025

(54) ELECTRONIC CIRCUIT FOR GENERATING A REFERENCE CURRENT USING TRANSISTORS IN THE WEAK INVERSION REGION OF OPERATION AND COMPRISING A TRIMMED RESISTOR

(71) Applicant: EM Microelectronic-Marin SA, Marin (CH)

(72) Inventor: Jiri NERAD, Praha 5 (CZ)

(73) Assignee: EM Microelectronic-Marin SA, Marin (CH)

(21) Appl. No.: 19/046,610

(22) Filed: Feb. 6, 2025

(30) Foreign Application Priority Data
Apr. 25, 2024 (EP) 24172535.7

(51) Int. Cl. G05F 3/26

(52) U.S. Cl. CPC G05F 3/262

(57) ABSTRACT

In an electronic circuit for producing a reference current by using weak inversion in MOS transistors (7, 8) while using degeneration in a resistor (10) at a floating voltage along an electric path (4) linking two supply lines (1, 2), adjustment of the reference current is obtained by trimming the resistor. Parallel branches (13) in the electric path (4) can be selectively activated by a switch controller (17) for allowing the current flowing through them. A part of the switches (15) is connected to one of the supply lines at a supply voltage, which allows a precise adjustment.

### CROSS REFERENCE TO RELATED APPLICATION

This application claims priority to European Patent Application No. 24172535.7 filed Apr. 25, 2024, the entire contents of which are incorporated herein by reference.

### FIELD OF THE INVENTION

This invention relates to an electronic circuit for generating a reference current using transistors in the weak inversion region of operation, the circuit also comprising a trimmed resistor.

### TECHNOLOGICAL BACKGROUND

Electronic circuits for generating a reference current using transistors in the weak inversion region of operation can be found in many common-use appliances, for instance those using coin batteries, in which the reference current must be produced at a low or ultra-low voltage (often less than 1V) and low or ultra-low power.

A good candidate is the so-called Vittoz loop, an embodiment of which is illustrated in FIG. 1. A first voltage Vdd is applied at a positive side supply line which is here a first supply rail 1, and a second, different voltage Vss is applied at a negative side supply line which is here a second supply rail 2. The first supply rail and second supply rail 1 and 2 are connected together by a pair of electrical paths 3 and 4. Each of the electrical paths 3 and 4 comprises a PMOS transistor, respectively 5 and 6, whose source is connected to the first supply rail 1, and a NMOS transistor, respectively 7 and 8, whose source is connected to the second supply rail 2. In the first electrical path 3, the drain of the PMOS transistor 5 is connected to the drain of the NMOS transistor 7 directly; but in the second electrical path 4, the drain of the PMOS transistor 6 is connected to the drain of the NMOS transistor 8 through a resistor 9 called a degeneration resistor. The gates of the PMOS transistors 5 and 6 are kept at a same voltage, but the gates of the NMOS transistors 7 and 8 are at different voltages as they are connected to parts of the second electrical path 4 respectively between the resistor 9 and the NMOS transistor 8, and between the opposite end of the resistor 9 and the PMOS transistor 6.

The operation of the circuit may be summarised as follows. The PMOS transistors 5 and 6 are identical and create a mirror stage of the electronic circuit with a same drain current. Further, the NMOS transistors 7 and 8, operated in weak inversion region with common source voltage, have the drain current proportional to exp (VGS/[n*VT]), where n is a slope factor between 1.2 and 1.6, VGS is the gate-source voltage and VT is a thermal voltage equal to (k*T/q), in which k is the Boltzmann constant, T the absolute temperature, and q the elementary charge. A drain current ID produces a voltage drop equal to (ID*R) across the resistor 9 and is equal to [n*VT*In (N)/R], in which N is a size scaling factor between the NMOS transistors 7 and 8. The value of the current ID is proportional to the absolute temperature T, is also inversely proportional to the resistance R, and increases if the scaling factor N is increased. 20

A trimming of the degeneration resistor 9 by additional switches would enable to modify its overall resistance and to obtain a reference current adjusted at a desired intensity in the electronic circuit. But although the particular topology of the circuit in FIG. 1 is valuable because it can operate at low voltages (less than 1V), it appears that a convenient trim of the resistor 9 is difficult at such low voltages because it is at a floating voltage, that is, unrelated to the voltages in the supply rails 1 and 2, since it is separated therefrom by the PMOS 6 and the NMOS 8 on the second electrical path 4. Thus, the known prior art lacks an electronic circuit for producing a reference current at low or ultra-low voltages and which comprises a degeneration resistor that can be trimmed without adverse effects.

### SUMMARY OF THE INVENTION

A purpose of the invention is therefore to improve electronic circuits similar to FIG. 1 so that a floating degeneration resistor they contain can be trimmed with a precision and reliability sufficient to obtain the desired value of the reference current without adverse effects due to voltage drops over the related switch transistors and at low or ultra-low voltages and low or ultra-low power consumption, and despite the dependence of the circuit on the absolute temperature. Thus, an improved topology is proposed.

According to a general definition of the invention, this purpose is fulfilled by an electronic circuit, comprising the said NMOS and PMOS transistors and degeneration resistor, wherein the electronic circuit is configured for generating a reference current in a weak inversion region of the said NMOS transistors, wherein the electronic circuit comprises:
a first supply line at a first voltage and a second supply line at a second voltage, wherein the resistor is at a voltage floating with respect to both the first voltage of the first supply line and the second voltage of the second supply line,
characterized in that the resistor is a tap resistor and in that the electronic circuit comprises a tap subcircuit comprising a set of switches and which is configured to tap the resistor,
wherein the tap subcircuit comprises separate tap branches, (all connected to the first supply line or all connected to the second supply line) each including at least one of the switches and a second transistor which forms a functional transistor operating in the weak inversion region in the tap branch,
wherein the switches are all connected to the first supply line or all connected to the second supply line, each tap branch is connected to a respective tap point of the resistor for tapping a respective resistance value of the resistor, and the functional transistors are respectively connected to the tap points,
and wherein the switches are each controlled by a switch controller for selectively opening or closing a connection of each branch with the first or second supply line.

The trimming operations of the resistor consist of adjustments of the resistance of the resistor. The important point is that, since the switches necessary for the adjustment are not at floating voltages, but on the contrary they comprise a part maintained at the voltage of the first or second supply line, the parasitic series resistances of the closed switches can be made arbitrarily small, limiting or eliminating the errors introduced by these switches into the operation or characteristic of the full circuit. The convenient location of the switches is allowed by the division of the second electrical path into the plurality of branches near the first or second supply line so that each of the switches is at this supply voltage. As a consequence, the functional transistors, present between the resistor and the first supply line in the topology of FIG. 1, are present in each of the branches.

Furthermore, the functional transistors are each controlled in the same manner, each functional transistor is preferably a MOS transistor, the gates of each second transistor are controlled with the same voltage; and/or the second transistors are structurally identical one with another and have identical dimensions.

Furthermore, to obtain uniform trim characteristic, the switches of each branch are structurally identical one with another and have identical dimensions.

The first supply line or the second supply line may be either a positive supply line with the functional transistors of the PMOS type, or a negative supply line, with the functional transistors of the NMOS type then.

In a particularly important embodiment of the invention, each switch includes a MOS transistor having a source terminal connected to the first or second supply rail and a gate controlled by the switch controller.

According to an important mode of operation, one and only of the switches, called the active switch, is controlled differently from the other switches of the set of switches by the switch controller, wherein the active switch is closed (or conductive) while all other switches are open (or non-conductive), that is, the switch controller is configured to allow current flowing into only one of the branches.

In particular embodiments, the switch of each branch includes a single transistor, comprising a channel forming a path between its source terminal and its drain terminal that is in series with a structurally identical channel between the source and drain of the functional transistor of the branch.

In such embodiments, each of the branches includes said single transistor of the switch that has a drain terminal and a source terminal, and the functional transistor, that has a drain terminal and a source terminal, all located along a common electric path or branch extending from the respective tap point to the first or second supply line.

But in other embodiments, the switch of each branch includes a transistor which is connected to the first or second supply line and a transfer gate which includes two transistors of opposite polarity, that is one NMOS transistor and one PMOS transistor.

Possible characteristics of such embodiments would consist in that each of the branches comprises a first electric path extending from the respective tap point to the first or second supply line, including the channel of the functional transistor, and a second electric path, distinct from said first electric path, connecting the first or second supply line to the transfer gate and including a channel of a switch transistor.

Also, the switch controller could comprise, for each of the branches, a first control path for controlling both the transfer gate and the transistor of the switch, and a second control path for controlling the transfer gate only.

Finally, the first control path could lead to a gate of the transistor of the switch and to the gate of a transistor of the transfer gate, said transistor of the transfer gate and said transistor of the switch being of opposite types among NMOS and PMOS type.

Another possible improvement, aimed at compensating the minor effect of the voltage drops over the switch devices on the operation or characteristic of the full circuit, involves a third transistor which is identical to the single transistor of the switch in embodiments mentioned above, wherein said third transistor is in a branch of the electronic circuit distinct from the tap branches and connects the first supply line to one of said first transistors.

The invention may particularly be implemented in electronic circuits comprising two supply lines at two different voltages, one positive and one negative, with two distinct electrical paths connecting the first supply line to the second supply line, the tap resistor and the tap subcircuit being parts of one of the electrical paths, the voltage of the resistor being floating with respect to both supply lines.

### SHORT DESCRIPTION OF THE FIGURES

The different aspects, characteristics and advantages of the invention will more completely appear in the description of the following figures, which disclose particular embodiments of the invention in a purely illustrative way:

FIG. 1 (already described): a conventional electronic circuit that can be improved by the invention;

FIG. 2: a first embodiment of the invention;

FIG. 3: a second embodiment of the invention;

FIG. 4: a third embodiment of the invention, combining the first and second embodiments;

FIG. 5: a fourth embodiment of the invention;

FIG. 6: a fifth embodiment of the invention.

### DETAILED DESCRIPTION OF THE INVENTION

A first embodiment of the invention, illustrated in FIG. 2, differs from the conventional circuit in the following features. The resistor 9 with a single resistive body providing the full amount of desired resistance is replaced by a tap resistor 10 made up of consecutive resistive segments 11 separated by tap points 12 spread along the tap resistor 10 (they include a tap point 12a at the low end of the tap resistor 10, remotest from the first supply rail 1). All the tap points 12 are connected by a branch 13 of a tap subcircuit 16 to the second supply rail 2 through the drain and source (or through the channel between the drain and source) of a functional NMOS transistor 14 and through the drain and source (or through the channel between the drain and source) of a switch device 15, which is another NMOS transistor having the source at the voltage Vss of the second supply rail 2. The tap subcircuit 16 is completed by a switch controller 17 comprising control paths 18 connected to the gates of the switches 15.

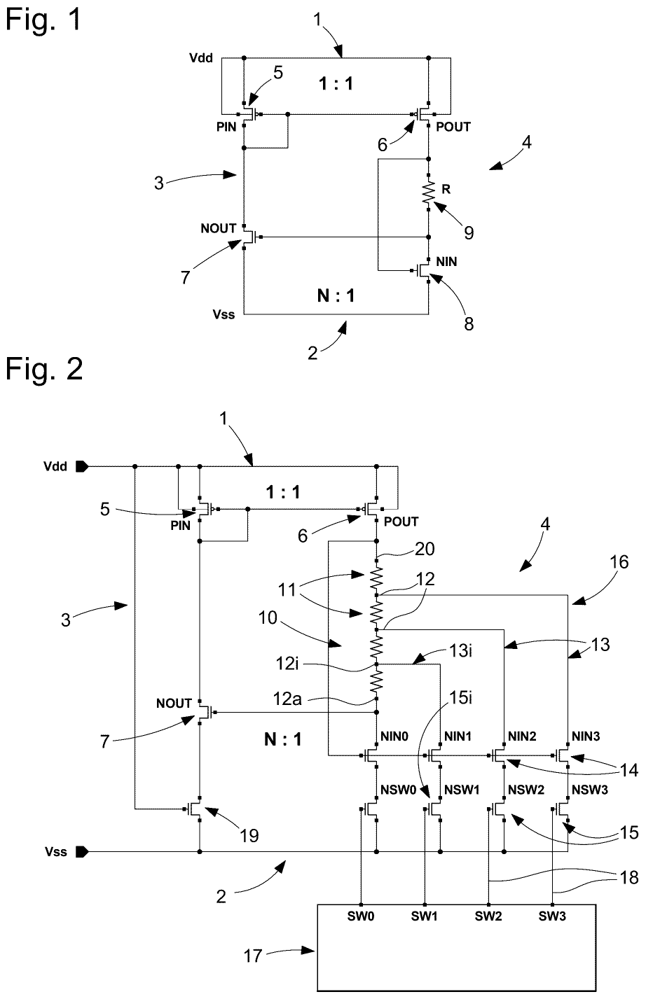

The tap subcircuit 16 replaces the negative side part (that is the resistor 9 and the NMOS transistor 8 connected to the second supply rail 2) of the second electrical path 4 in the conventional circuit of FIG. 1. The devices 14 replace the NMOS transistor 8 and are copies thereof which may be quite identical and whose gates are at a same voltage, again the voltage at the drain of the PMOS transistor 6. Also, the switches 15 are preferably identical one to another. Other parts of the conventional circuit need not be modified. In the present embodiments, a further NMOS transistor 19 is nevertheless added in the first electrical path 3. Its drain is connected to the NMOS transistor 7, its source to the second supply rail 2, its gate to the first supply rail 1 It is preferably identical to the single transistors embodying the switches 15. Also, it is an optional component to replicate a minor amount of voltage drop that may exist over the switch transistors 15 in order to remove or compensate its effect on the operation or characteristic of the full circuit.

The functionality and operation of the improved circuit will be described now. The switch controller 17 is programmed to turn on or close a selected one of the switches 15, and turn off or open the remaining ones. That is, one and only of switches 15 is closed or conductive and all others are open or non-conductive. Further, the circuit transistors 14 are designed to be conductive and have their operating points in the weak inversion region. Thus, electric current will flow only in the branch 13 having the switch 15 closed or conductive, the others being inactive. When a particular branch 13i is chosen to be conductive, the electric reference current ID in the second electrical path 4 will flow only in those segments 11 between the corresponding tap point 12i of this branch 13i and the high end 20 (closest to the first supply rail 1) of the tap resistor 10, while the remainder of the tap resistor 10, between said tap point 12i and the tap point 12a at the low end, will conduct no current and therefore generate no voltage drop, effectively acting as a short circuit providing the bias voltage to the NMOS transistor 7 but making no contribution to the characteristics of the reference current ID provided by the electronic circuit. The trim of the tap resistor 10 consists of this shunt of a selected number of low side segments 11. It can be performed accurately because the switches 15 are grounded, that is their source terminals are at the voltage of the second supply rail 2, and consequently, their resistance or voltage drops in the closed or conductive state can be made arbitrarily small.

All the switches 15 being grounded, the inactive part of the tap resistor 10 (between tap points 12a and 12i) has no significant current through it and the voltage at the low end of the active part of the tap resistor can normally be transferred without adverse effect. Nevertheless, if a leakage current through the inactive part means a significant risk, floating switches can be added in parallel with the corresponding segments 11 to form an optional shunt of the inactive segments 11.

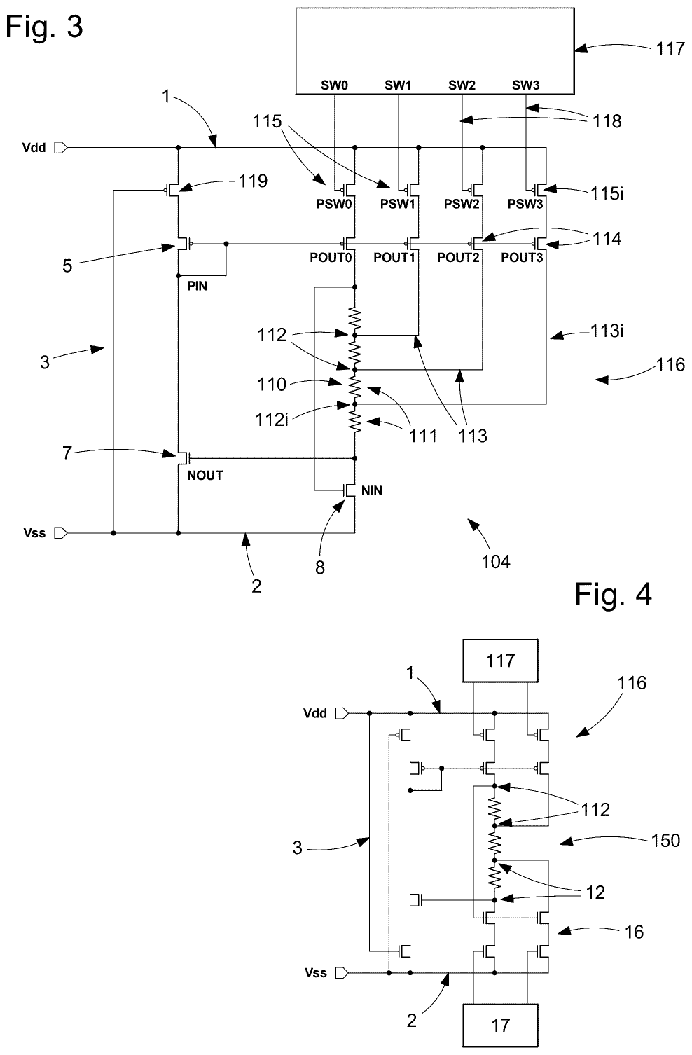

FIG. 3 illustrates another embodiment of the invention, in which novel components corresponding to those in FIG. 2 will be indicated with the same number incremented by 100. The electronic circuit of FIG. 3 comprises a tap subcircuit 116 comprising branches 113, each connecting a distinct tap point 112 of a tap resistor 110 to the first supply rail 1, and each of the branches 113 being provided with a switch 115 and a functional transistor 114. The drains of the switches 115 are connected to the sources of the functional transistors 114, the sources of the switches 115 are connected to the first supply rail 1 and are maintained at the same supply voltage Vdd, and the drains of the functional transistors 114 are connected to the respective tap points 112. Like in the previous embodiment, the tap points 112 are spread along the tap resistor 110 and divide it into successive segments 111. A switch controller 117 is added for controlling the switches 115 with control paths 118 driving their gates. The switch transistors 115 and functional transistors 114 are transistors of the PMOS type in this embodiment. Again, all the switches 115 are preferably identical to each other, and all the functional transistor 114 are preferably identical to each other, and the functional transistors 114 are identical copies of the PMOS transistor 6 of the prior art shown in FIG. 1 and their purpose is to provide identical functionality. Also, the functional transistors 114 have gates controlled at a voltage identical to the voltage at the gate of the PMOS transistor 5 that is part of the first electrical path 3 between the PMOS transistor 5 and the NMOS transistor 7 as shown in FIG. 1.

An important difference from the previous embodiment is that the tap subcircuit 116 is at the positive side of the second electrical path 104, the NMOS transistor 8 at the negative side of the present second electrical path 104 is still present, and the functional transistor 114 replace the PMOS transistor 6. Otherwise the operation of this embodiment is similar: a selected one of the switches 115i is turned on by the switch controller 117, the connection of the corresponding branch 113i is closed while the connections of the other branches 113 remain open, and the tap resistor 110 is divided into an active part through which the reference current ID flows, and an inactive part which carries no current and generates no voltage drop, these parts joining at the tap point 112i where the branch 113i connects the tap resistor 110. However, the active part is at the low side (closer to the NMOS transistor 8), and the inactive part at the high side (closer to the first supply rail 1).

Again, the selection of a particular branch 113 for flowing the electric current thereby enables to trim the tap resistor 110 to a desired value and to produce the reference current ID having the desired characteristics.

Like in the embodiment of FIG. 2, an optional component may be added in the first electrical path 3 to replicate the minor voltage drop over the switches 15 and therefore compensate or remove their effect on the operation or characteristic of the full circuit. Here it consists in a PMOS transistor 119 whose source is connected to the first supply rail 1, its drain to the source of the PMOS transistor 5, and its gate to the second supply rail 2.

A further possibility consists in cumulating the improvements of FIGS. 2 and 3 in one electronic circuit, shown in FIG. 4. The second electrical path is made by combining the negative side tap subcircuit 16, with the positive side tap subcircuit 116, also combining the tap resistors 10 and 110 into a single tap resistor 150, in which the tap points 12 at the low part are connected to the tap subcircuit 16, and the tap points 112 at the high part to the tap subcircuit 116. This arrangement allows, for example, to trim the tap resistor 10 at both ends, only a central part being always active. The PMOS transistor 6 and the NMOS transistor 8 in the second electrical path 4 of FIG. 1 are represented and included as multiple copies of functional transistors in the same way as devices 14 and 114 in FIGS. 2 and 3, respectively. The switch controllers 17 and 117 of the tap subcircuits 16 and 116 effectively form a single control functionality and may be replaced by a single controller block.

In all these embodiments, each of the branches 13 and 113 has an arrangement in which a single electric path, in which the electric current flows when the branch 13 or 113 is active, comprises the channel (that is the path between the source and drain) of one of the switches 15 or 115, and the channel (that is the path between the source and drain) of one of the functional transistors 14 or 114. Further, the functional transistors 14 and 114 were separated from the first or the second supply rail 1 or 2 by the switches 15 or 115. But these characteristics are not absolutely fundamental for this invention.

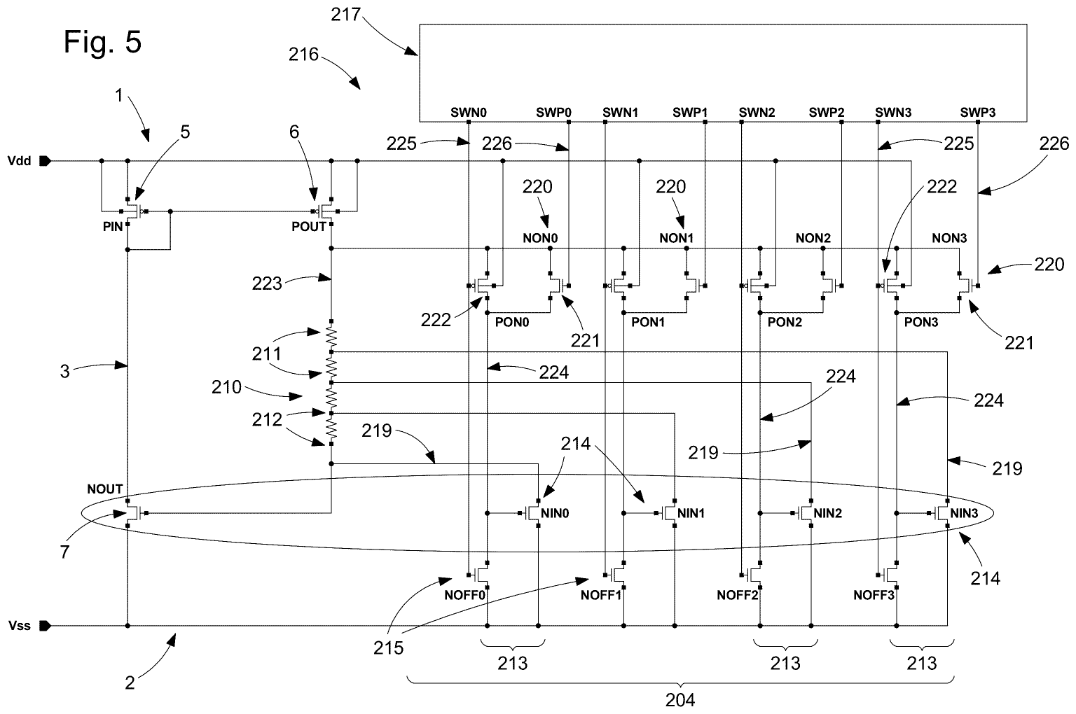

A different kind of embodiments will be described now. FIG. 5 illustrates another electronic circuit, in which the second electrical path, now 204, is provided with a tap subcircuit 216 having the following features:
branches 213 each comprising a main electric path 219 and a switched electric path 224;
the main electric paths 219 connecting respective tap points 212 of a tap resistor 210 to the second supply rail 2, and provided with the drains and sources of functional transistors 214 of NMOS type;
transfer gates 220 made of a NMOS type transistor 221 and a PMOS type transistor 222, both forming parallel switches having a first terminal connected to an electric path 223 connected to the source of the PMOS transistor 6 of the second electrical path 204;
the switched electric paths 224 from a second terminal of the transfer gate or the parallel switches 220 formed by the NMOS transistor 221 and of the PMOS transistor extending down to the second supply rail 2 through the channel or the path between the drain and source of the respective switches 215 of the NMOS type;
a switch controller 217 comprising, for each transfer gate 220, each branch 213 or each switch 215, a pair of control paths: a first control path 225 leading to the gate of the PMOS transistor 222 of the transfer gate and to the gate of the NMOS transistor of the switch 215, and a second control path 226 leading to the gate of the NMOS transistor 221 of the transfer gate 220.

Like in FIG. 2, the NMOS transistor 8 is now represented by and included as multiple copies of functional transistor 214.

The tap subcircuit 216 is controlled as follows. For any pair of associated or complementary control paths 225 and 226, one of the paths is at a high voltage and the other at a low voltage so that the switch transistors 221 and 222 of the transfer gate 220 are both closed (conductive) or both open (non-conductive) at the same time. Further, the switches 215 being of NMOS type, their state (closed versus open, conductive versus non-conductive) will be the opposite of the state of both the NMOS transistor 221 and the PMOS transistor 222 on the same path 224. The two operation modes will result in the following:
when the first path 225 is at the high voltage and the second path 226 at the low voltage, the transfer gate 220 is open (non-conductive) the switch 215 is closed (conductive), no control voltage appears at the control path 224 from the transfer gate 220, the functional transistor 214 carries no current and no current flows in the associated main electric path 219, hence the respective branch 213 is inactive, further the gate of the functional transistor 214 is discharged or grounded or connected through the switch 215 towards the second supply rail 2;
when the first path 225 is at the low voltage and the second path 226 at the high voltage, the transfer gate 220 is closed (conductive), the switch 215 is open (non-conductive), the gate of the circuit transistor 214 is at the full voltage present at the drain of the PMOS transistor 6, the functional transistor 214 is biased (carries current), the current flows in the main electric path 219 and the corresponding branch 213 is active.

Like in the previous embodiments, the switch controller 217 allows to select one and only of the branches 213 to become active and all others inactive so that a variable number of segments 211 at an end of the tap resistor 210 will become inactive and the characteristics of the reference current output by the electronic circuit will be adjusted.

This embodiment retains the advantages of the embodiments of FIGS. 2 to 4, no floating switches have a significant or noticeable effect on the characteristic of the circuit. This is because the transfer gates 220, which are the only floating switch elements in this topology, carry no significant current even when active, hence generating no voltage drop and acting as ideal switches.

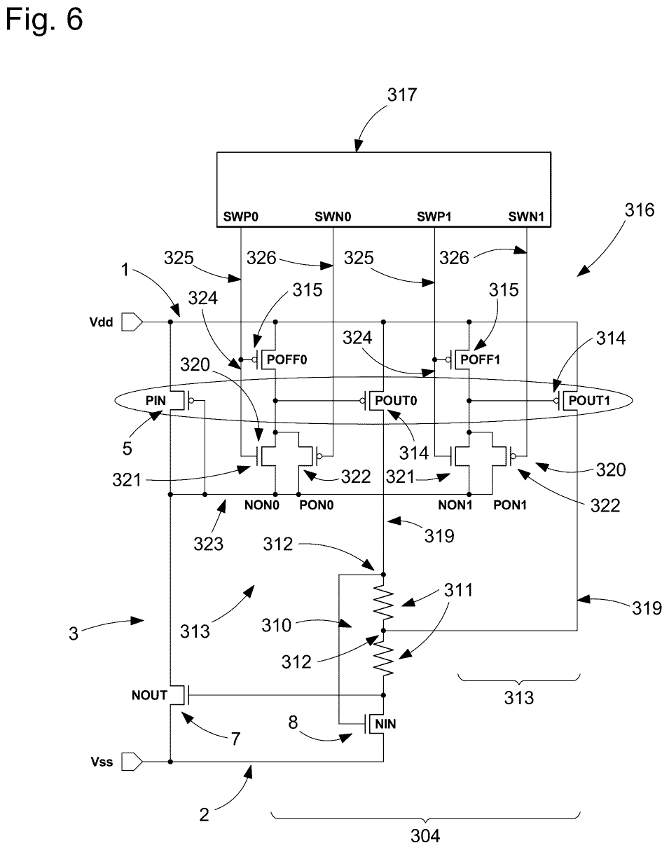

However, the switches could as well be maintained at the other supply voltage of the electronic circuit. A corresponding arrangement is shown in FIG. 6, which illustrates another embodiment of the invention. The second electrical path 304 is provided with a tap subcircuit 316 having the following features:
branches 313 each comprising a main electric path 319 and a control path 324;
the main electric paths 319 connecting respective tap points 312 of a tap resistor 310 to the first supply rail 1, and provided with the channel (that is the path between the source and drain) of functional transistors 314 of PMOS type;
transfer gates 320 made of a NMOS type transistor 321 and a PMOS type transistor 322, having one terminal connected to an electric path 323 connected to the drain of the PMOS transistor 5 of the first electrical path 303;
the control paths 324 from the drains of the NMOS transistor 321 and of the PMOS transistor 322 of the transfer gate 320 extending up to the first supply rail 1 through the channel (that is the path between the source and drain) of respective switches 315 of the PMOS type;
a switch controller 317 comprising, for each transfer gate 320, each branch 313 or each switch 315, a pair of control paths: a first control path 325 driving the gate of the NMOS transistor 321 of the transfer gate and the gate of the switch 315, and a second control path 326 driving the gate of the PMOS transistor 322 of the transfer gate 320.

Like in FIG. 3, the PMOS transistor 7 is now represented and included as multiple copies 314 of the functional transistor.

The tap subcircuit 316 is controlled as follows. For any pair of associated or complementary control paths 325 and 326, one of the paths is at a high voltage and the other at a low voltage so that the switch transistors 321 and 322 of the transfer gate 320 are both closed (conductive) or open (non-conductive) at the same time. Further, the switches 315 being of PMOS type, their state (closed versus open, conductive versus non-conductive) will be the opposite of the state of the NMOS transistor 321 on the same control path 325. The two operation modes will result in the following:
when the first control path 325 is at the low voltage and the second control path 326 at the high voltage, the transfer gate 320 is open (non-conductive), the switch 315 is closed (conductive), the gate of the corresponding functional transistor 314 is at the full supply voltage 1, and, as the circuit transistor 314 is of PMOS type, it is also open (non-conductive), no current flows through the main electric path 319 and the corresponding branch 313 is inactive;
when the first control path 325 is at the high voltage and the second control path 326 is at the low voltage, the transfer gate 320 is closed (conductive), the switch 215 is open (non-conductive), the gate of the functional transistor 314 is at the full voltage present at the drain of PMOS transistor 5 which is connected through the transfer gate 320 and the path 324, the circuit transistor 314 becomes biased (carries current), therefore an electric current flows through the main electric path 319 and the corresponding branch 313 is active.

Again, the switch controller 317 allows to select one and only of the branches 313 to become active and all others inactive so that a variable number of segments 311 at an end of the tap resistor 310 will become inactive and the characteristics of the reference current output by the electronic circuit will be adjusted. In this embodiment, the drains of the switches 315 are maintained at the supply voltage Vdd of the first supply rail 1, so that their resistance in the closed (conductive) state can be made arbitrarily small. Also, no floating switches have a significant or noticeable effect on the characteristic of the full circuit because the transfer gates 320 being the only floating switch elements in this topology, carry no significant current even when active, hence generating no voltage drop and acting as ideal switches.

### NOMENCLATURE

1. First supply rail
2. Second supply rail
3. First electrical path
4. Second electrical path
5. PMOS transistor
6. PMOS transistor
7. NMOS transistor
8. NMOS transistor
9. Resistor
10, 110, 210, 310. Tap resistor
11, 111, 211, 311. Segment of the tap resistor
12, 112, 212, 312. Tap point
13, 113, 213, 313. Branch of the tap subcircuit
14, 114, 214, 314. Functional transistor
15, 115, 215, 315. Switch transistor
16, 116, 216, 316. Tap subcircuit
17, 117, 217, 317. Switch controller
18, 118. Control path
19. NMOS transistor
20. High end (of the tap resistor)
119. PMOS transistor
219, 319 Main electric path
220, 320. Transfer gate
221. NMOS transistor
222. PMOS transistor
223. Electric path
224, 324. Control path
225, 325. First control path
226, 326. Second control path
321. PMOS transistor
322. NMOS transistor
323. Electric path
ID Reference current
Vdd Drain voltage
Vss Source voltage

1. An electronic circuit, comprising PMOS transistors (5, 6) and NMOS transistors (7, 8) and a degeneration resistor, wherein the electronic circuit is configured to generate a reference current (ID) using the weak inversion operation of the NMOS transistors, wherein the electronic circuit comprises:
a first supply line (1) at a first voltage (Vdd) and a second supply line (2) at a second voltage (Vss), wherein the resistor (10, 110, 210, 310) is at a voltage floating with respect to both the first voltage of the first supply line and the second voltage of the second supply line,
wherein the resistor is a tap resistor (10, 110, 210, 310) and in that the electronic circuit comprises a tap subcircuit (16, 116, 216, 316) comprising a set of switches (15, 115, 215, 315; 220, 320) and a set of second transistors (14, 114, 214, 314) each connected to a respective switch, which is configured to tap the resistor,
wherein the tap subcircuit comprises separate tap branches (13, 113, 213, 313) each including at least one of the switches and one second transistor (14, 114, 214, 314) which forms a functional transistor operating in the weak inversion region,
wherein the switches are all connected either to the first supply line (1) or to the second supply line (2), each tap branch being connected to a respective tap point (12, 112, 212, 312) of the resistor for tapping a respective resistance value of the resistor, and each second or functional transistor (14, 114, 214, 314) being respectively connected to the respective tap point,
and wherein the switches (15, 115, 215, 315; 220, 320) are each controlled by a switch controller (17, 117, 217, 317) for selectively opening or closing a connection of each branch to the first supply line (1) or second supply line (2).

2. The electronic circuit according to claim 1, wherein the second or functional transistors (14, 114, 214, 314) are each operated in the same manner, wherein each second transistor is preferably a MOS transistor, the gates of each of the second transistors being controlled or driven at a same voltage.

3. The electronic circuit according to claim 1, wherein the second or functional transistors are structurally identical one with another and/or have identical dimensions.

4. The electronic circuit according to claim 1, wherein the first supply line (1) is a positive supply line and the second or functional transistors (114, 314) are PMOS devices and are connected to the supply line (1) via switch transistors (115, 315) which are also PMOS devices, and/or wherein the second supply line is a negative supply line 2) and the second transistors (14, 214) are NMOS devices and are connected to the supply line (2) via switch transistors (15, 215) which are also NMOS devices.

5. The electronic circuit according to claim 1, wherein the switches (15, 115, 215, 315) of each branch are structurally identical one with another and/or have identical dimensions.

6. The electronic circuit according to claim 1, wherein each of the switches (15, 115, 215, 315) includes a MOS transistor having either a source terminal or a drain terminal connected to the first supply line (1) or the second supply line (2) and a gate terminal controlled by the switch controller (17, 117, 217, 317).

7. The electronic circuit according to claim 1, wherein one of the switches (15i), called the active switch, is controlled differently from the other switches of the set of switches by the switch controller, and/or the switch controller is configured to allow current flowing into only one of the branches (13i).

8. The electronic circuit according to claim 1, wherein the switch of each branch includes a single transistor (15, 115).

9. The electronic circuit according to claim 1, wherein the switch of each branch includes a transistor (215, 315) which is connected to the first supply line (1) or the second supply line (2), and a transfer gate (220, 320) comprising two transistor devices of opposite type, that is one NMOS device (221, 321) and one PMOS device (222, 322).

10. The electronic circuit according to claim 8, wherein in each of the branches (13, 113) said single transistor of the switch (15, 115) has a channel between its drain terminal and its source terminal, and the functional transistor (14, 114) has a channel between its drain terminal and its source terminal, both channels being in series along a common electric path extending from the respective tap point (12, 112) to the first supply line (1) or the second supply line (2).

11. The electronic circuit according to claim 9, wherein each of the branches (213, 313) comprises a first electric path (219, 319) which extends from the respective tap point (212, 312) to the first supply line (1) or the second supply line (2) and which includes the channel between the source terminal and the drain terminal of the second or functional transistor (14, 114), and a second electric path (224, 324), distinct from said first electric path, connecting the first supply line (1) or the second supply line (2) to the transfer gate (220, 320) and which includes the channel between the source terminal and drain terminal of the switch transistor (215, 315).

12. The electronic circuit according to claim 11, wherein the switch controller (217, 317) comprises, for each of the branches (213, 313), a first control path (225, 325) for controlling both the transfer gate (220, 320) and the switch transistor (215, 315) of the switch, and a second control path (226, 326) for controlling the transfer gate (225, 325) only, the second control line providing a signal that is complementary to the one provided on the first control line (225, 325).

13. The electronic circuit according to claim 12, wherein the first control path (225, 325) drives a gate of the transistor (215, 315) of the switch and the gate of a transistor (222, 322) of the transfer gate, said transistor (222, 322) of the transfer gate and said transistor (215, 315) of the switch being of opposite types among NMOS and PMOS type.

14. The electronic circuit according to claim 8, further comprising a third transistor (19, 119) which is identical to the single transistor instance of the switch (15, 115), wherein the channel or the path between the source terminal and drain terminal of said third transistor (19, 119) is in a branch of the electronic circuit distinct from the tap branches (13, 113), and connects the first supply line (1) or the second supply line (2) to one of said first transistors (5, 7) and its gate terminal is connected to the opposite of the first supply line (1) or the second supply line (2).

15. The electronic circuit according to claim 1, wherein the tap points in said tap resistor (10, 110, 210, 310) are distributed uniformly or non-uniformly, creating equal or non-equal resistive segments (11, 111, 211, 311).
